(19) United States
(12) Patent Application Publication
(10) Pub. No.: US 2026/0019536 A1
(43) Pub. Date: Jan. 15, 2026

(54) ALERT AND INCIDENCE MANAGEMENT SYSTEM

(71) Applicants: Madhukeshwar S Yavagal, Bangalore (IN); Poornima S Yavagal, Bangalore (IN)

(72) Inventors: Madhukeshwar S Yavagal, Bangalore (IN); Poornima S Yavagal, Bangalore (IN)

(21) Appl. No.: 19/269,172

(22) Filed: Jul. 15, 2025

(30) Foreign Application Priority Data
Jul. 15, 2024 (IN) 202441053932

(51) Int. Cl. H04N 7/18; G06K 7/14; G06K 19/06; G06V 20/40; G06V 20/52; G06V 40/16; G08B 25/00

(52) U.S. Cl. CPC H04N 7/181; G06V 20/44; G06V 20/53; G06V 40/166; G08B 25/005; G08B 25/009; G06K 7/1417; G06K 19/06112

(57) ABSTRACT

According to an exemplary aspect of the disclosed embodiment, a system for management of alerts and incidents related to providing security in an environment is provided. The system includes a plurality of monitoring devices deployed in the environment, each monitoring device designed to capture a corresponding monitor data related to the environment; a plurality of portable devices operated by one or more users present in the environment, each portable device providing a pre-configured list of alerts, wherein each user using a respective portable device is enabled to select a corresponding alert from the pre-configured list of alerts; and a control server operable to receive and display in a dashboard, the corresponding monitor data from the plurality of monitoring devices and the corresponding alerts selected by users in the plurality of portable devices.

### PRIORITY CLAIM

The instant patent application is related to and claims priority from the India provisional Patent Application no: 202441053932, Filed on: 15 Jul. 2024, entitled, “ALERT AND INCIDENT MANAGEMENT SYSTEM”, which is incorporated in its entirety herewith.

### TECHNICAL FIELD OF THE DISCLOSED EMBODIMENT

The disclosed embodiment is in the technical field of computing and more particularly, to an alert and incident management system.

### BACKGROUND OF THE DISCLOSED EMBODIMENT

Traditional methods to store a data of the occurrence of the real time incidence and historical incidence are mostly manual processes. Report writing and the documentation are manually written by an individual from the captured information about a specific incident or events data such as who was involved, what happened, when it happened, where it happened, what caused it to happen and other relevant details. This is documented in paper forms, logbooks, or spreadsheets.

Ad-hoc method needs a physical presence of the workers to communicate the present incident happening which has a delay. Manual incident triage which is a step to evaluate severity and tackle the incident and manual escalation of incidence is taken into higher management teams which prevents predefined incident management. The information of incidents is not shared within the departments of the organization which makes any decision making ineffective.

The response time for the incident is slow, chances of errors are mostly higher and the tasks performed are manual. Such as manual process leads to a slowdown in the growth of the organization and analysis of data in documents are difficult and the changes of the incidence document takes longer duration. As such, traditional methods lack in limitation of progress, date sharing, predefined incident decision making, collaboration and automation workflow.

Therefore, there is an urgent need to develop an alert and incidence management system to overcome the difficulties faced by the organization or people by traditional methods and manual reporting of the incidence.

### SUMMARY OF THE DISCLOSED EMBODIMENT

According to an exemplary aspect of the disclosed embodiment, a system for management of alerts and incidents related to providing security in an environment is provided. The system includes a plurality of monitoring devices deployed in the environment, each monitoring device designed to capture a corresponding monitor data related to the environment; a plurality of portable devices operated by one or more users present in the environment, each portable device providing a pre-configured list of alerts, wherein each user using a respective portable device is enabled to select a corresponding alert from the pre-configured list of alerts; and a control server operable to receive and display in a dashboard, the corresponding monitor data from the plurality of monitoring devices and the corresponding alerts selected by users in the plurality of portable devices.

According to another aspect of the disclosed embodiment, the plurality of monitoring devices comprises closed circuit television (CCTV) cameras, wherein the plurality of portable devices comprises mobile phones and mobile tablets.

According to further aspect of the disclosed embodiment, the environment is one of an event management, a healthcare facility, a border security location, and a disaster response situation, wherein the one or more users comprises security guards, custodians, police personnel, and firefighters.

According to yet another aspect of the disclosed embodiment, the control server is operable to facilitate an administrator to specify any desired alerts to be included in the pre-configured list of alerts, wherein each portable device is designed to retrieve the pre-configured list of alerts from the control server.

According to one more aspect of the disclosed embodiment, the pre-configured list of alerts comprises one or more of fire alarm triggered, medical emergency alert, power failure alert, severe weather warning, violence or fight alert, and crowd control alert.

According to another aspect of the disclosed embodiment, the control server is operable to facilitate an administrator to specify any desired tasks to be included in a pre-configured list of tasks. Each portable device also retrieves and provides the pre-configured list of tasks, wherein each user using the respective portable device is required to perform each task in the pre-configured list of tasks and to indicate a corresponding status of performance of the task using the respective portable device. The control server is also operable to receive and display in the dashboard, the corresponding statuses indicated by users in the plurality of portable devices.

According to further aspect of the disclosed embodiment, the pre-configured list of tasks comprises one or more of patrol the premises, monitor surveillance systems, check lighting systems, check entry/exit points, time log maintenance, housekeeping, equipment check, visitor log, report writing, check perimeter, and gate duty.

According to yet another aspect of the disclosed embodiment, each user is required to login to the respective portable device before the commencement of a shift. A first user after completion of the shift, generates a handshake data using a first portable device, with a second user being required to enter the handshake data into a second portable device to indicate the transfer of responsibility from the first user to the second user.

According to one more aspect of the disclosed embodiment, the handshake data is a quick-response (QR) code, wherein the QR code is generated and displayed on the first portable device, wherein the second user enter the handshake data by scanning the displayed QR code using the second portable device.

According to another aspect of the disclosed embodiment, the control server is operable to determine an entry person count and an exit person count based on an analysis of the corresponding monitor data received from the plurality of monitoring devices. The entry person count and the exit person count are used to identify a count of the persons present in the environment at any given time instance.

According to further aspect of the disclosed embodiment, the corresponding monitor data comprises video footage received from one or more monitoring devices stationed at one or more detection zones within the environment, wherein the analysis comprises detecting using facial recognition techniques each person in the video footage.

According to yet another aspect of the disclosed embodiment, each portable device also provides a set of break types, wherein each user using the respective portable device is required to select a corresponding break type prior to taking a break and to provide a confirmation after completion of the break. The respective portable device is operable to, in response to the selection of the corresponding break type, display a duration allocated to the corresponding break type and to send an escalation incident to the control server if the confirmation is not received within the duration. The control server is also operable to receive and display in the dashboard, the corresponding break types indicated by users in the plurality of portable devices and also the escalation incidents received from the plurality of portable devices.

According to an exemplary aspect of the disclosed embodiment, a method for management of alerts and incidents related to providing security in an environment is performed in a control server. The method comprises: receiving, from a plurality of monitoring devices deployed in the environment, a corresponding monitor data related to the environment captured by each monitoring device; receiving, from a plurality of portable devices operated by one or more users present in the environment, a corresponding alert selected from a pre-configured list of alerts, wherein the selection is performed by each user using a respective portable device; and displaying in a dashboard, the corresponding monitor data received from the plurality of monitoring devices and the corresponding alerts received from the plurality of portable devices.

According to another aspect of the disclosed embodiment, the method comprises facilitating an administrator to specify any desired alerts to be included in a pre-configured list of alerts; and providing the pre-configured list of alerts to each of the plurality of portable devices.

According to further aspect of the disclosed embodiment, the method comprises facilitating an administrator to specify any desired tasks to be included in a pre-configured list of tasks; providing the pre-configured list of tasks to each of the plurality of portable devices, wherein each user using the respective portable device is required to perform each task in the pre-configured list of tasks; and receiving, from a plurality of portable devices, a corresponding status of performance of each task using the respective portable device. The displaying also displays in the dashboard, the corresponding statuses indicated by users in the plurality of portable devices.

According to yet another aspect of the disclosed embodiment, each user is required to login to the respective portable device before the commencement of a shift. The method comprises: generating a handshake data using the portable device; and entering the handshake data into another portable device used by another user to indicate the transfer of responsibility from the user to another user.

According to one more aspect of the disclosed embodiment, the method comprises receiving video footage from one or more monitoring devices stationed at one or more detection zones within the environment; detecting using facial recognition techniques each person in the video footage; determining an entry person count and an exit person count based on the detecting; and using the entry person count and the exit person count to identify a count of the persons present in the environment at any given time instance.

Several aspects of the disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### BRIEF DESCRIPTION OF THE DRAWINGS

Example embodiments of the disclosed embodiment will be described with reference to the accompanying drawings briefly described below

FIG. 1 is a block diagram illustrating an example computing system (100) in which various aspects of the present disclosure can be implemented.

FIG. 2 is a flow chart illustrating the manner in which the management of alerts and incidents related to providing security in an environment is facilitated, according to aspects of the present disclosure.

FIG. 3 illustrates the manner in which an alert and incident management system is implemented in one embodiment.

FIGS. 4A-4D depict sample user interfaces related to management of monitor data and alerts in one embodiment.

FIGS. 5A-5D depict sample user interfaces related to management of tasks required to be performed by users in one embodiment.

FIGS. 6A-6D depict sample user interfaces related to management of breaks availed by users in one embodiment.

FIGS. 7A-7B depict sample user interfaces related to handshake data for transfer of responsibility from a first user to a second user in one embodiment.

FIG. 8 is a block diagram illustrating the details of a digital processing system in which various aspects of the present disclosure are operative by execution of appropriate execution modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE DISCLOSED EMBODIMENT

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

Reference throughout this specification to “one embodiment”, “an embodiment”, or similar language means that a particular feature, structure, or characteristic described in disclosed embodiment. Thus, appearances of the phrases “in one embodiment”, “in an embodiment” and similar language throughout this specification may, but do not necessarily, all refer to the same embodiment.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

As used herein, the singular forms “a”, “an”, and “the” include both singular and plural referents unless the context clearly dictates otherwise. By way of example, “a dosage” refers to one or more than one dosage. The terms “comprising”, “comprises” and “comprised of” as used herein are synonymous with “including”, “includes” or “containing”, “contains”, and are inclusive or open-ended and do not exclude additional, non-recited members, elements, or method steps.

Example embodiments of the present disclosure are described with reference to the accompanying figures.

### 1. Example Computing System

FIG. 1 is a block diagram illustrating an example computing system (100) in which various aspects of the present disclosure can be implemented. The block diagram is shown containing end user systems 110a-110c, monitoring devices 120a-120c, network 130, and cloud 160 (which in turn is shown containing a number of nodes such as node 170a and 170b, control server 150 and data store 180).

Merely for illustration, only representative number/type of systems is shown in FIG. 1. Many computing systems often contain many more systems, both in number and type, depending on the purpose for which the computing system is designed. Each system/device of FIG. 1 is described below in further detail.

Network 130 provides connectivity between end user systems 110a-110c, mobile devices 120a-120c, and nodes of cloud 160 (such as node 170a/170b, control server 150 and data store 180). Network 130 may represent Wireless/LAN networks implemented using protocols such as Transport Control Protocol/Internet Protocol (TCP/IP), or circuit switched network implemented using protocols such as GSM, CDMA, etc. as is well known in the relevant arts.

In general, network 130 provides transport of packets, with each packet containing a source address (as assigned to the specific system from which the packet originates) and a destination address, equaling the specific address assigned to the specific system to which a packet is destined/targeted. The packets would generally contain the requests and responses between the various systems connected via network 130 as described in detail in the below sections.

Each of end user systems 110a-110c represents a system such as a personal computer, workstation, mobile phone (e.g., iPhone available from Apple Corporation), tablet, portable device (also referred to as “smart” devices”) that operate with a generic operating system such as Android operating system available from Google Corporation, etc., used by users to send (user) requests to nodes of cloud 160 such as control server 150. In addition, each of end user systems 110a-110c may include various hardware (and corresponding software) sensors such as camera, microphone, accelerometers, etc. In general, an end user system enables a user to send user requests for performing desired tasks to control server 150 and to receive corresponding responses containing the results of performance of the requested tasks.

Some of end user systems 110a-110c may correspond to portable devices (such as mobile phones, mobile tablets) used by users present in an environment (such as an event management). Other end user systems may correspond to desktops/laptops used by administrators to configure the various aspects of the present disclosure.

Each of monitoring devices 120a-120c represents a system that is used to capture monitor data related to the environment (noted above) in which they are deployed. For example, monitoring devices such as closed-circuit television (CCTV) cameras, temperature sensors, admission counters/trackers, etc. may be deployed in the environments noted above to capture corresponding monitor data (video feeds, temperature readings, access cards punched in/out, etc.) as will be apparent to one skilled in the relevant arts.

Cloud 160 is a collection of nodes (such as node 170a/170b) that may include processing nodes, connectivity infrastructure, data storages, administration systems, etc., which are engineered to together host software applications. Cloud 160 may be provided on a public cloud infrastructure (such as Amazon Web Services (AWS) available from Amazon.com, Inc., Google Cloud Platform (GCP) available from Google LLC, etc.) that provides a virtual computing infrastructure for various customers, with the scale of such computing infrastructure being specified often on demand. Alternatively, cloud 160 may be provided on an enterprise system (or a part thereof) on the premises of the business organizations. Cloud 160 may also be a “hybrid” infrastructure containing some nodes of a public cloud infrastructure and other nodes of an enterprise system.

It may be appreciated that each of control server 150 and data store 180 are implemented on corresponding nodes of cloud 160. Some of the other nodes (such as node 170a/170b) of cloud 160 may be implemented as corresponding data stores similar to data store 180, while other nodes of the cloud 160 may be implemented as corresponding server systems, similar to control server 150.

Data store 180 represents a non-volatile storage, facilitating storage and retrieval of a collection of data by control server 150. A data store may maintain information such as user data received from end user systems 110a-110c, data related to performance of tasks noted above, etc. In one embodiment, a data store is implemented using relational database technologies where the data is maintained in the form of databases containing tables and columns and provides storage and retrieval of data using structured queries such as SQL (Structured Query Language), as is well known in the relevant arts. Alternatively, a data store may be implemented as a file server and store data in the form of one or more files organized in the form of a hierarchy of directories, as is well known in the relevant arts.

Control server 150 represents a server, such as a web and/or application server, executing various applications designed to perform one or more tasks requested from end user systems. Each server may perform the tasks using data maintained internally in the server, on external data (e.g., maintained in data store 180) or on data received as part of the requests (e.g., data received from end user systems 110a-110c). Each server may also send the results of performance of the tasks to end user systems 110a-110c or one or more nodes of cloud 160. Furthermore, each server may maintain some of the received information (such as the data from end user systems 110a-110c) and the result of performance of the tasks in data store 180.

Control server 150 along with end user systems 110a-110c, monitoring devices 120a-120c, and data store 180 represents an alert and incident management system according to aspects of the present disclosure. In one embodiment, control system 150 is designed to facilitate the management of alerts and incidents related to providing security in an environment (such as those noted above). The manner in which control server 150 may facilitate such management of alerts and incidents is described below with examples.

### 2. General Flow

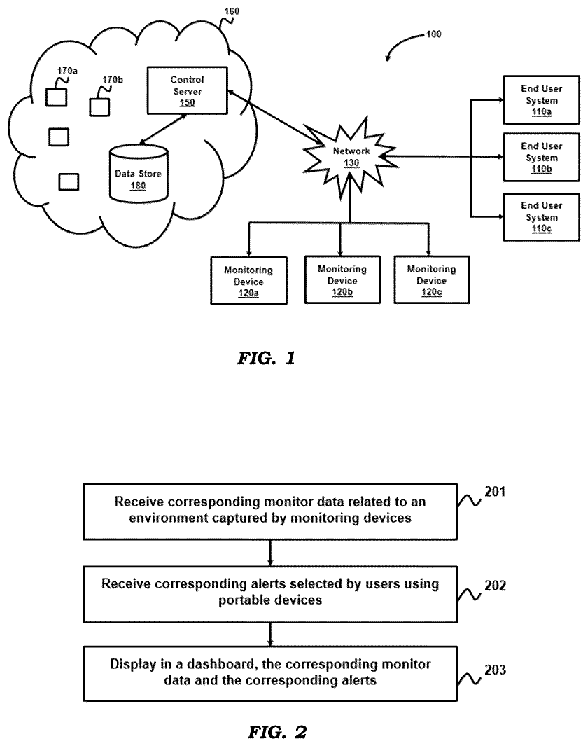

FIG. 2 is a flow chart illustrating the manner in which the management of alerts and incidents related to providing security in an environment is facilitated according to aspects of the present disclosure. The flowchart is described with respect to FIG. 1, in particular, control server 150, merely for illustration. However, various features can be implemented in other systems and/or other environments also without departing from the scope of various aspects of the present disclosure, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present disclosure.

In step 201, control server 150 receives corresponding monitor data related to an environment captured by monitoring devices (120a-120c). The environment may be one of an event management, a healthcare facility, a border security location, and a disaster response situation.

In step 202, control server 150 receives corresponding alerts selected by users using portable devices (some of end user systems 110a-110c). In the above noted environment, the users may be security guards, custodians, police personnel, firefighters, etc. According to an aspect, the corresponding alerts are selected from a pre-configured list of alerts that may include one or more of fire alarm triggered, medical emergency alert, power failure alert, severe weather warning, violence or fight alert, and crowd control alert.

In step 203, control server 150 displays in a dashboard (a single/common user interface), the corresponding monitor data received from the monitoring devices and the corresponding alerts received from the portable devices. The dashboard may be displayed on a display unit (not shown) associated with/connected to control server 150 or one of end user systems 110a-110c, as will be apparent to one skilled in the arts.

Thus, aspects of the disclosure facilitate the management of alerts and incidents related to providing security in an environment. The manner in which control server 150 according to the operation of FIG. 2 may be provided is described below with examples.

### 3. Illustrative Example

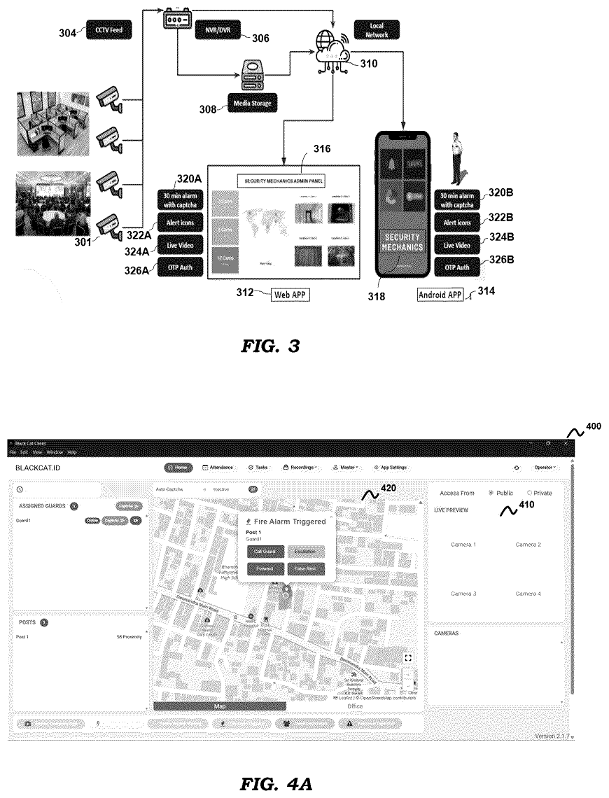

FIG. 3 illustrates the manner in which an alert and incident management system is implemented in one embodiment. The block diagram is shown containing cameras 301, CCTV feed 304, network/digital video recorder (NVR/DVR) 306, media storage 308, cloud platform 310, web application (app) 312 and mobile/android application/app 314. Each of the blocks is described in detail below.

Cameras 301 are placed under a particular position to analysis the incidence happening and capture the in live video footage. CCTV feed 304 feeds the information of the pre-incident and stores the real time incidence footages. Network/digital video recorder 306 converts analog footage to digital footage which is received by media storage 308 which stores the digital data for further use (for example, to check whether the same incidence occurs). All this are stored and processed in cloud-based platform 310 (containing control server 150 and data store 180).

Mobile/android app 314 has a security mechanism (318) inbuilt for the users, along with the ability to indicate 30-minute alarm with captcha (320B), alert icons (322B) if there is an emergency, live video (324B) where a user can do a video call if any emergency and OTP (one time password) authentication/authorization (326B) when the user logins for his/her work.

A security mechanism admin panel (316) is inbuilt in a web app (312) for monitoring each place. There are 30-minute alarm with captcha (320A), alert icons (322A) if there is an emergency, live video (324A) between the administrator and the users if any emergency is present and OTP authentication/authorization (326A) for login for his/her shift.

These processes are made so that there is an interaction between the users (security guards, custodians, etc.) and administrators who monitor the overall view for the monitoring of the incidence management, the user activities and for safety and security purpose of the people in the environment. Some sample user interfaces that may be provided by an alert and incident management system is described below with examples.

### 4. Sample User Interfaces

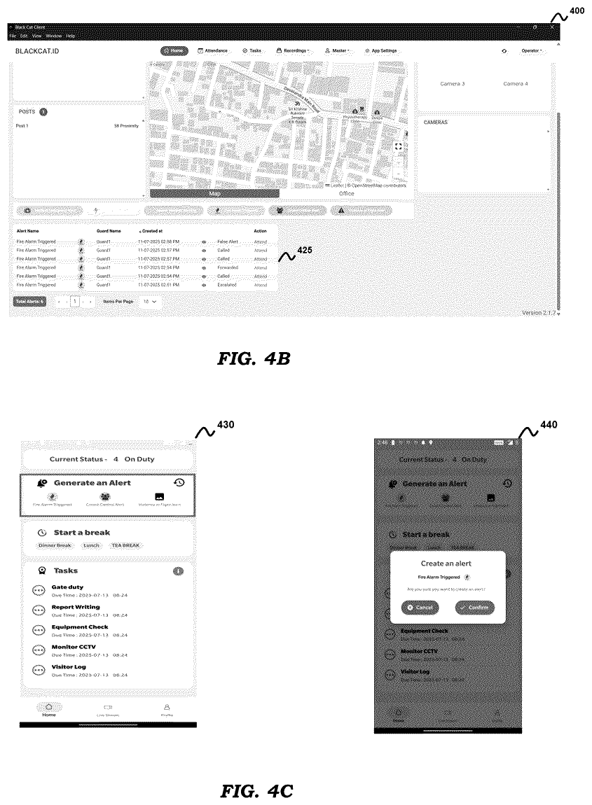

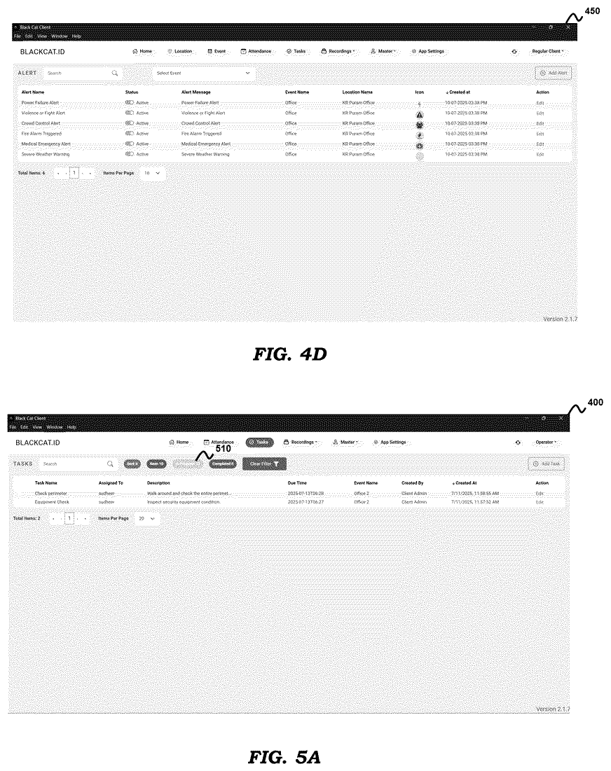

FIGS. 4A-4D depict sample user interfaces related to management of monitor data and alerts in one embodiment. Referring to FIG. 4A, display area 400 depicts a dashboard displayed by control server 150. The dashboard is containing display area 410 displaying the monitor data (video feeds) received from monitoring devices 120a-120c (herein, cameras) and display area 420 displaying an alert selected by a user (here, a guard) using a portable device (one of end user systems 110a-110c). Referring to FIG. 4B, display area 425 displays all the alerts selected by users using their respective devices.

Referring to FIG. 4C, display area 430 shows the pre-configured list of alerts being displayed to a user on his/her portable device, while display area 440 shows the manner in which the user is enabled to select/create an alert from the pre-configured list of alerts. Referring to FIG. 4D, display area 450 shows a user interface using which an administrator is facilitated to specify any desired alerts to be included in the pre-configured list of alerts.

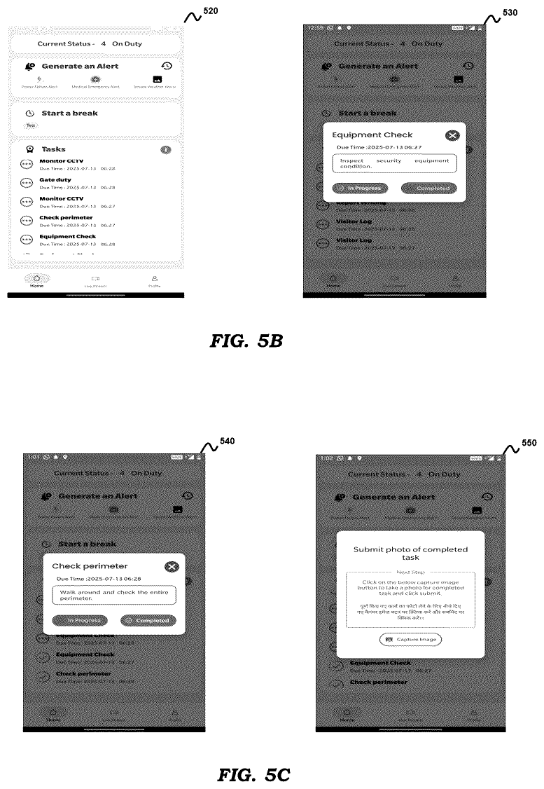

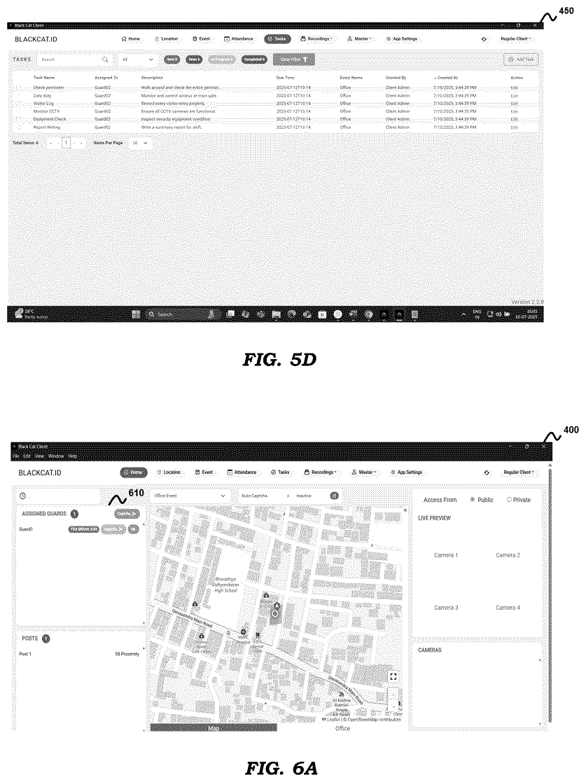

FIGS. 5A-5D depict sample user interfaces related to management of tasks required to be performed by users in one embodiment. Referring to FIG. 5A, display area 400 depicts a dashboard displayed by control server 150, with the dash board showing the status (here, “In Progress” as indicated by display area 510) of tasks performed by the users (guards).

Referring to FIG. 5B, display area 520 shows the pre-configured list of tasks being displayed to a user on his/her portable device, while display area 530 shows the manner in which the user is enabled to change the status (“In Progress”) of a task (“Equipment Check”) from the pre-configured list of tasks.

Referring to FIG. 5C, display area 540 shows the manner in which the user is enabled to change the status (“Completed”) of a task (“Equipment Check”) from the pre-configured list of tasks, while display area 550 indicates an action to be performed by the user upon completion of the task. Referring to FIG. 5D, display area 450 shows a user interface using which an administrator is facilitated to specify any desired tasks to be included in the pre-configured list of tasks.

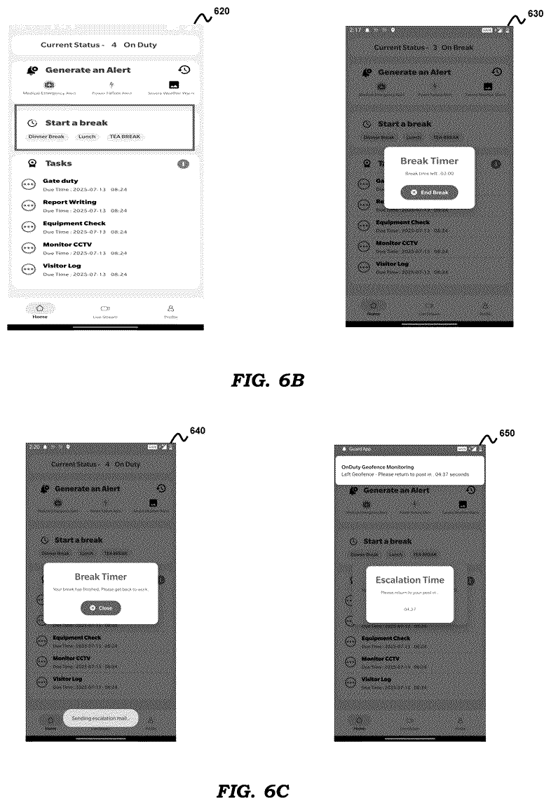

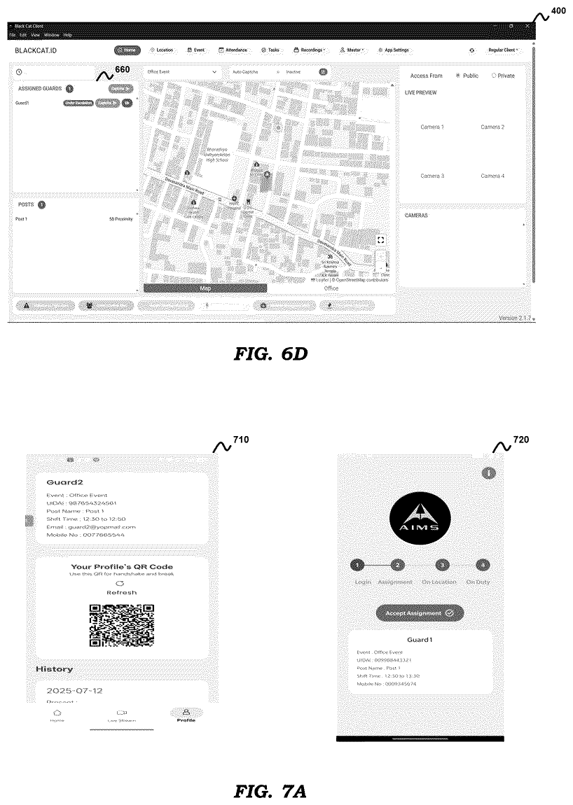

FIGS. 6A-6D depict sample user interfaces related to management of breaks availed by users in one embodiment. Referring to FIG. 6A, display area 400 depicts a dashboard displayed by control server 150, with the dash board showing the details of the break types (here, “Tea Break” as indicated by display area 610) availed by the users (guards).

Referring to FIG. 6B, display area 620 shows the set of break types being displayed to a user on his/her portable device, while display area 630 shows the manner in which a timer (duration) is displayed to the user upon selection of a break type (“Tea Break”) from the set of break types.

Referring to FIG. 6C, display area 640 indicates that an escalation incident (here, mail) has been raised in view of the user having not provided a confirmation (selection of “End Break” in display area 630) within the duration allocated for the selected break type. Display area 650 indicates the time elapsed post the escalation incident. Referring to FIG. 6D, display area 660 shows that an escalation incident has been raised with respect to a user/guard (here, “Guard1”).

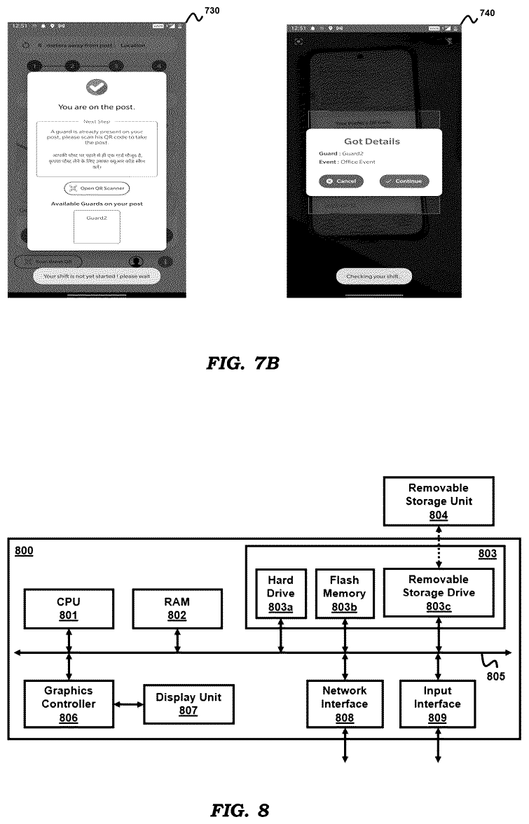

FIGS. 7A-7B depict sample user interfaces related to handshake data for transfer of responsibility from a first user to a second user in one embodiment. Referring to FIG. 7A, display area 710 shows a QR code generated on a portable device of a first user, here, Guard 2 who is currently completing a shift from 12:30 to 12:150. Display area 720 indicates that a second user, that is, Guard 1, using a second portable device, is ready to accept the next shift from 12:50 to 13:30.

Referring to FIG. 7B, display area 730 shows that the second user is prompted to scan the QR code displayed on the first portable device of the first user, while display area 740 indicates that that the QR code has been successfully scanned, and hence the transfer of responsibility from the first user to the second user is accordingly confirmed.

It should be further appreciated that the above noted features can be implemented in various embodiments as a desired combination of one or more of hardware, execution modules and firmware. The description is continued with respect to one embodiment in which various features are operative when execution modules are executed.

### 5. Hardware

FIG. 8 is a block diagram illustrating the details of digital processing system (800) in which various aspects of the present disclosure are operative by execution of appropriate execution modules. Digital processing system 800 may correspond to control system 150 or any of end user systems 110a-110c.

Digital processing system 800 may contain one or more processors (such as a central processing unit (CPU) 801), random access memory (RAM) 802, secondary memory 803, graphics controller 806, display unit 807, network interface 808, and input interface 809. All the components except display unit 807 may communicate with each other over communication path 805 which may contain several buses as is well known in the relevant arts. The components of FIG. 8 are described below in further detail.

CPU 801 may execute instructions stored in RAM 802 to provide several features of the present disclosure. CPU 801 may contain multiple processing units, with each processing unit potentially being designed for a specific task. Alternatively, CPU 801 may contain only a single general-purpose processing unit. RAM 802 may receive instructions from secondary memory 803 using communication path 805.

Graphics controller 806 generates display signals (e.g., in RGB format) to display unit 807 based on data/instructions received from CPU 801. Display unit 807 contains a display screen (e.g., LED lights) to display the images defined by the display signals (e.g., the user interfaces of FIGS. 4A-4D, 5A-5D, 6A-6D and 7A-7B). Input interface 809 may correspond to a keyboard and a pointing device (e.g., touch-pad, mouse), which enable the various inputs to be provided (e.g., inputs provided via user interfaces of FIGS. 4A-4D, 5A-5D, 6A-6D and 7A-7B).

Network interface 808 provides connectivity to a network (e.g., using Internet Protocol), and may be used to communicate with other connected systems. Network interface 808 may provide such connectivity over a wire (in the case of TCP/IP based communication) or wirelessly (in the case of Wi-Fi, Bluetooth based communication).

Secondary memory 803 may contain hard drive 803a, flash memory 803b, and removable storage drive 803c. Secondary memory 803 may store the data (e.g., pre-configured list of alerts, pre-configured list of tasks, etc.) and software instructions (e.g., for implementing the steps of FIG. 2 and other aspects of the present disclosure), which enable digital processing system 800 to provide several features in accordance with the present disclosure.

Some or all of the data and instructions may be provided on removable storage unit 804, and the data and instructions may be read and provided by removable storage drive 803c to CPU 801. Floppy drive, magnetic tape drive, CD-ROM drive, DVD Drive, Flash memory, and removable memory chip (PCMCIA Card, EPROM) are examples of such removable storage drive 803c.

Removable storage unit 804 may be implemented using storage format compatible with removable storage drive 803c such that removable storage drive 803c can read the data and instructions. Thus, removable storage unit 804 includes a computer readable storage medium having stored therein computer software (in the form of execution modules) and/or data.

However, the computer (or machine, in general) readable storage medium can be in other forms (e.g., non-removable, random access, etc.). These “computer program products” are means for providing execution modules to digital processing system 800. CPU 801 may retrieve the software instructions (forming the execution modules) and execute the instructions to provide various features of the present disclosure described above.

Merely for illustration, only representative number/type of graph, chart, block, and sub-block diagrams were shown. Many environments often contain many more block and sub-block diagrams or systems and sub-systems, both in number and type, depending on the purpose for which the environment is designed.

While specific embodiments of the disclosure have been shown and described in detail to illustrate the inventive principles, it will be understood that the disclosure may be embodied otherwise without departing from such principles.

It should be understood that the figures and/or screen shots illustrated in the attachments highlighting the functionality and advantages of the disclosed embodiment are presented for example purposes only. The disclosed embodiment is sufficiently flexible and configurable, such that it may be utilized in ways other than that shown in the accompanying figures.

All documents (publications, patents, and patent applications) cited in the present specification are hereby incorporated by reference in their totality. In particular, the teachings of all documents herein specifically referred to are incorporated by reference.

It should be understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A system for management of alerts and incidents related to providing security in an environment, the system comprising:
a plurality of monitoring devices deployed in the environment, each monitoring device designed to capture a corresponding monitor data related to the environment;
a plurality of portable devices operated by one or more users present in the environment, each portable device providing a pre-configured list of alerts, wherein each user using a respective portable device is enabled to select a corresponding alert from the pre-configured list of alerts; and
a control server operable to receive and display in a dashboard, the corresponding monitor data from the plurality of monitoring devices and the corresponding alerts selected by users in the plurality of portable devices.

2. The system of claim 1, wherein the plurality of monitoring devices comprises closed circuit television (CCTV) cameras, wherein the plurality of portable devices comprises mobile phones and mobile tablets.

3. The system of claim 1, wherein the environment is one of an event management, a healthcare facility, a border security location, and a disaster response situation, wherein the one or more users comprises security guards, custodians, police personnel, and firefighters.

4. The system of claim 1, wherein the control server is operable to facilitate an administrator to specify any desired alerts to be included in the pre-configured list of alerts, wherein each portable device is designed to retrieve the pre-configured list of alerts from the control server.

5. The system of claim 4, wherein the pre-configured list of alerts comprises one or more of fire alarm triggered, medical emergency alert, power failure alert, severe weather warning, violence or fight alert, and crowd control alert.

6. The system of claim 1, wherein the control server is operable to facilitate an administrator to specify any desired tasks to be included in a pre-configured list of tasks,
wherein each portable device also retrieves and provides the pre-configured list of tasks, wherein each user using the respective portable device is required to perform each task in the pre-configured list of tasks and to indicate a corresponding status of performance of the task using the respective portable device,
wherein the control server is also operable to receive and display in the dashboard, the corresponding statuses indicated by users in the plurality of portable devices.

7. The system of claim 6, wherein the pre-configured list of tasks comprises one or more of patrol the premises, monitor surveillance systems, check lighting systems, check entry/exit points, time log maintenance, housekeeping, equipment check, visitor log, report writing, check perimeter, and gate duty.

8. The system of claim 1, wherein each user is required to login to the respective portable device before the commencement of a shift,
wherein a first user after completion of the shift, generates a handshake data using a first portable device,
wherein a second user is required to enter the handshake data into a second portable device to indicate the transfer of responsibility from the first user to the second user.

9. The system of claim 8, wherein the handshake data is a quick-response (QR) code, wherein the QR code is generated and displayed on the first portable device, wherein the second user enter the handshake data by scanning the displayed QR code using the second portable device.

10. The system of claim 1, wherein the control server is operable to determine an entry person count and an exit person count based on an analysis of the corresponding monitor data received from the plurality of monitoring devices,
wherein the entry person count and the exit person count are used to identify a count of the persons present in the environment at any given time instance.

11. The system of claim 10, wherein the corresponding monitor data comprises video footage received from one or more monitoring devices stationed at one or more detection zones within the environment,
wherein the analysis comprises detecting using facial recognition techniques each person in the video footage.

12. The system of claim 1, wherein each portable device also provides a set of break types, wherein each user using the respective portable device is required to select a corresponding break type prior to taking a break and to provide a confirmation after completion of the break,
wherein the respective portable device is operable to, in response to the selection of the corresponding break type, display a duration allocated to the corresponding break type and to send an escalation incident to the control server if the confirmation is not received within the duration,
wherein the control server is also operable to receive and display in the dashboard, the corresponding break types indicated by users in the plurality of portable devices and also the escalation incidents received from the plurality of portable devices.

13. A method for management of alerts and incidents related to providing security in an environment, the method being performed in a control server, the method comprising:
receiving, from a plurality of monitoring devices deployed in the environment, a corresponding monitor data related to the environment captured by each monitoring device;
receiving, from a plurality of portable devices operated by one or more users present in the environment, a corresponding alert selected from a pre-configured list of alerts, wherein the selection is performed by each user using a respective portable device; and
displaying in a dashboard, the corresponding monitor data received from the plurality of monitoring devices and the corresponding alerts received from the plurality of portable devices.

14. The method of claim 13, further comprising:
facilitating an administrator to specify any desired alerts to be included in a pre-configured list of alerts; and
providing the pre-configured list of alerts to each of the plurality of portable devices.

15. The method of claim 14, wherein the pre-configured list of alerts comprises one or more of fire alarm triggered, medical emergency alert, power failure alert, severe weather warning, violence or fight alert, and crowd control alert.

16. The method of claim 13, further comprising:
facilitating an administrator to specify any desired tasks to be included in a pre-configured list of tasks;
providing the pre-configured list of tasks to each of the plurality of portable devices, wherein each user using the respective portable device is required to perform each task in the pre-configured list of tasks; and
receiving, from a plurality of portable devices, a corresponding status of performance of each task using the respective portable device,
wherein the displaying also displays in the dashboard, the corresponding statuses indicated by users in the plurality of portable devices.

17. The method of claim 16, wherein the pre-configured list of tasks comprises one or more of patrol the premises, monitor surveillance systems, check lighting systems, check entry/exit points, time log maintenance, housekeeping, equipment check, visitor log, report writing, check perimeter, and gate duty.

18. The method of claim 13, wherein each user is required to login to the respective portable device before the commencement of a shift, the method further comprising:
generating a handshake data using the portable device; and
entering the handshake data into another portable device used by another user to indicate the transfer of responsibility from the user to another user.

19. The method of claim 18, wherein the handshake data is a quick-response (QR) code, wherein the method comprises after the generating, displaying the QR code on the display unit associated with the portable device, wherein the entering the handshake data comprises scanning the displayed QR code using another portable device.

20. The method of claim 13, further comprises:
receiving video footage from one or more monitoring devices stationed at one or more detection zones within the environment;
detecting using facial recognition techniques each person in the video footage;
determining an entry person count and an exit person count based on the detecting; and
using the entry person count and the exit person count to identify a count of the persons present in the environment at any given time instance.
